(19) United States
(12) Patent Application Publication
(10) Pub. No.: US 2022/0385526 A1
(43) Pub. Date: Dec. 1, 2022

(54) FACILITATING LOCALIZATION OF FAULTS IN CORE, EDGE, AND ACCESS NETWORKS

(71) Applicant: AT&T Intellectual Property I, L.P., Atlanta, GA (US)

(72) Inventors: Lucus Haugen, Ponte Vedra Beach, FL (US); Rudolph Mappus, Plano, TX (US); Jianlei Zhang, Allen, TX (US)

(21) Appl. No.: 17/335,888

(22) Filed: Jun. 1, 2021

(51) Int. Cl. H04L 12/24

(52) U.S. Cl. CPC H04L 41/0654; H04L 41/0677; H04L 41/065

(57) ABSTRACT

Facilitating localization of faults in core, edge, and access networks is provided herein. Operations of a system can include establishing a restoration of a group of communication paths of a network infrastructure that includes network nodes between a root network node and a leaf network node. A fault is determined to exist in the group of communication paths between the root network node and the leaf network node. The operations also can include determining that a defined network node of the network nodes is a source of the fault based on respective positions of user equipment experiencing the fault relative to the defined network node. Further, the operations can include removing the fault based on controlling a functionality of the defined network node.

### TECHNICAL FIELD

This disclosure relates generally to the field of network communication management and, more specifically, to identifying points of communication failures within communications networks.

### BACKGROUND

The use of computing devices is ubiquitous. Demands are placed upon operators of communications networks for always ready access and the ability for users to perform desired actions without interruption. Accordingly, when a communication failure occurs, the elimination of such failure in a timely manner is demanded by users. Thus, determining when network equipment fail, taking action to maintain network throughput at all points in the network, and minimizing user downtime are important factors. Accordingly, unique challenges exist related to rapidly restoring services when outages or other communication failures occur.

### BRIEF DESCRIPTION OF THE DRAWINGS

Various non-limiting embodiments are further described with reference to the accompanying drawings in which:

FIG. 1 illustrates an example, non-limiting, simplified portion of a service provider network;

FIG. 2 illustrates an example, non-limiting, simplified portion of a service provider network represented as a tree architecture;

FIG. 3 illustrates an example, non-limiting, system that facilitates fault detection in core, edge, and access networks in accordance with one or more embodiments described herein;

FIG. 4 illustrates an example, non-limiting, computer-implemented method for localizing faults having a single failure point in accordance with one or more embodiments described herein;

FIG. 5 illustrates an example, non-limiting, computer-implemented method for using trouble report metadata for improving trouble localization in accordance with one or more embodiments described herein;

FIG. 6 illustrates an example, non-limiting, schematic representation of a network architecture in accordance with one or more embodiments described herein;

FIG. 7 illustrates another example, non-limiting, schematic representation of a network architecture in accordance with one or more embodiments described herein;

FIG. 8 illustrates an example, non-limiting, schematic representation of a network architecture for root cause interference in accordance with one or more embodiments described herein;

FIG. 9 illustrates an example, non-limiting, system for localizing faults in a communications network in accordance with one or more embodiments described herein;

FIG. 10 illustrates an example, non-limiting, computer-implemented method for localizing faults having a single failure point in accordance with one or more embodiments described herein;

FIG. 11 illustrates an example, non-limiting, computer-implemented method for recovering a network infrastructure to localize one or more communication failures in a communications network in accordance with one or more embodiments described herein;

FIG. 12 illustrates an example, non-limiting, computer-implemented method for localizing a communication fault based on assigning weights to nodes in a communications network in accordance with one or more embodiments described herein;

FIG. 13 illustrates an example, non-limiting, block diagram of a handset operable to engage in a system architecture that facilitates wireless communications according to one or more embodiments described herein; and

FIG. 14 illustrates an example, non-limiting, block diagram of a computer operable to engage in a system architecture that facilitates wireless communications according to one or more embodiments described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details (and without applying to any particular networked environment or standard).

Described herein are systems, methods, articles of manufacture, and other embodiments or implementations that can facilitate localization of faults in core, edge, and access networks. Determining when network equipment fail, taking actions to maintain network throughput at all points of the network, and minimizing user equipment downtime are useful capabilities for network service providers. The ability to rapidly restore services when outages occur is a distinguishing feature for consumers of network services, but there are many challenges for network service providers. For example, a challenge can be localizing a trouble when devices (e.g., network equipment) fail. Some network equipment notify other network equipment when problems arise, such as by raising alarms. However, when a network equipment fails, the lack of alarm data does not mean a device has failed (or has not failed). In fact, detecting when a device has failed based on its output alarms is a variation of a halting problem, a problem shown to be undecidable for Turing machines. Network equipment are in the class of Turing machines, therefore, determining when network equipment have failed from their output is undecidable. However, being able to localize failures helps to maximize network throughput over time and can minimize technician workloads for network service providers. Further complicating the concern are transient network paths, established for a short duration or even for data transmission during a single communication session. As the network paths are temporary, transient networks (often implemented for software defined networks) complicate trouble isolation efforts in network transmission components even when reporting alarms. As soon as a path is established, performs its function in transmitting data (as expected or otherwise), the path is removed and no longer available for confirmation of a fault or validation of successful restoration of a confirmed fault.

The various embodiments provided herein address these needs by using endpoint trouble reports to improve localization of network troubles accuracy over alarm-based detection. In an example, endpoints report losses of service troubles to their service provider (e.g., autonomously by the device or manually by a user). Endpoint trouble reports are logged or mapped to the endpoint account. Such mapping enables linkage between the endpoint trouble reports and the network equipment used to deliver services to the endpoints. Further, the commonalities among impacted final endpoints (e.g., user equipment) can assist with transient network paths and for identifying root cause components within these temporary networks.

In one embodiment, described herein is a method that includes determining, by a device including a processor, that communication failures have been experienced by a first user equipment and a second user equipment of a group of user equipment. The method also includes facilitating, by the device, recovery of a network infrastructure that includes network equipment determined to deliver respective services to the first user equipment and the second network equipment, a first path connecting the network equipment with the first user equipment, and a second path connecting the network equipment with the second user equipment. Further, the method includes superimposing, by the device, a first representation of respective locations of the first user equipment and the second user equipment onto a second representation of the network infrastructure. Also, the method includes identifying, by the device, a shared network equipment of the network equipment based on the shared network equipment being included in the first path and the second path. The method further includes facilitating, by the device, implementation of an action at the shared network equipment. The action is responsive to the communication failures.

In an example, the shared network equipment is a lowest common node within the network infrastructure. In another example, identifying the shared network equipment includes determining the first path and the second path are a same path. According to another example, identifying the shared network equipment includes determining the first path and the second path are linked at the shared network equipment.

In accordance with an implementation, prior to superimposing the first representation and the second representation, the method can include determining that the network equipment further delivers services to a third user equipment. Superimposing the first representation and the second representation can include superimposing a third representation of a third location of the third user equipment onto the network infrastructure. Additionally, a communication failure is not indicated at the third user equipment.

According to an example, facilitating the recovery can include recreating transient portions of the first path. The transient portions can be associated with a software defined network.

In some implementations, facilitating the recovery can include facilitating a first recovery of a first group of network equipment and facilitating a second recovery of a second group of trees of the network infrastructure. The first group of network equipment is representative of a first group of trees of the network infrastructure. Respective first trees of the first group of trees represent respective first network infrastructure equipment utilized to deliver a first service of the respective services to the first user equipment. Respective second trees of the second group of trees represent second network infrastructure equipment utilized to deliver a second service of the respective services to the second user equipment. Further to these implementations, the method can include, prior to facilitating the first recovery of the first group of trees, determining that a defined threshold value indicative of a minimum number of user equipment permitted to experience communication failures has been satisfied.

In some implementations, identifying the shared network equipment can include weighting the network equipment based on respective proximities of the network equipment to the first user equipment and the second user equipment. According to some implementations, identifying the shared network equipment can include weighting the network equipment based on respective arrival times of indications of the communication failures.

Another embodiment relates to a system that can include a processor and a memory that stores executable instructions that, when executed by the processor, facilitate performance of operations. The operations can include establishing a restoration of a group of communication paths of a network infrastructure that includes network nodes between a root network node and a leaf network node. A fault is determined to exist in the group of communication paths between the root network node and the leaf network node. The operations also can include determining that a defined network node of the network nodes is a source of the fault based on respective positions of user equipment experiencing the fault relative to the defined network node. Further, the operations can include removing the fault based on controlling a functionality of the defined network node.

In some implementations, determining the source of the fault can include determining that the respective positions of the user equipment are represented along a communication path. Further, the defined network node is the closest node to the user equipment experiencing the fault.

According to some implementations, other nodes, other than the root network node and the leaf network node and located between the defined network node and the user equipment, are determined not to be common to the user equipment experiencing the fault. Further to these implementations, the operations can include eliminating the other nodes as being a source of the fault.

Determining the source of the fault can include determining that first communication paths and second communication paths of the group of communication paths diverge at the defined network node, according to some implementations.

The operations can include, in some implementations, applying respective weights to the network nodes based on respective proximities of the network nodes to the user equipment and based on respective arrival times of information indicative of the fault. Further to these implementations, the operations can include identifying the defined network node based on the defined network node being assigned a weight of the respective weights that is more than weights of the respective weights assigned to other network nodes other than the defined network node.

Establishing the restoration of a group of communication paths can include, according to some implementations, restructuring transient portions of the group of communication paths. The transient portions can be associated with a software defined network.

A further embodiment relates to a non-transitory machine-readable medium, including executable instructions that, when executed by a processor, facilitate performance of operations. The operations can include recovering a network infrastructure based on a determination that a communication fault has occurred within a network. The network infrastructure can include a group of network equipment determined to provide services to a group of user equipment, a first path connecting the group of network equipment with first user equipment of the group of user equipment, and a second path connecting the group of network equipment with second user equipment of the group of user equipment. The operations also can include selecting a network equipment from the group of network equipment based on the network equipment being the closest network equipment to the first user equipment and the second user equipment, and based on the network equipment being utilized to provide services to the first user equipment and the second user equipment. Selecting the network equipment can identify the network equipment as a source of the communication fault.

According to some implementations, the operations can include determining the network equipment is the closest network equipment based on the network equipment being a node that routes first data via the first path to the first user equipment and second data via the second path to the second user equipment.

In accordance with some implementations, the network equipment is a first network equipment and the operations further include determining the first network equipment is the closest network equipment based on detection of the communication fault existing between the first network equipment and a second network equipment. In some implementations, the second network equipment is in a closer proximity to the first user equipment than the first network equipment. However, in these implementations, it is determined that the second network equipment is not the cause of the communication fault due to the second network equipment not being common to both the first user equipment and the second user equipment.

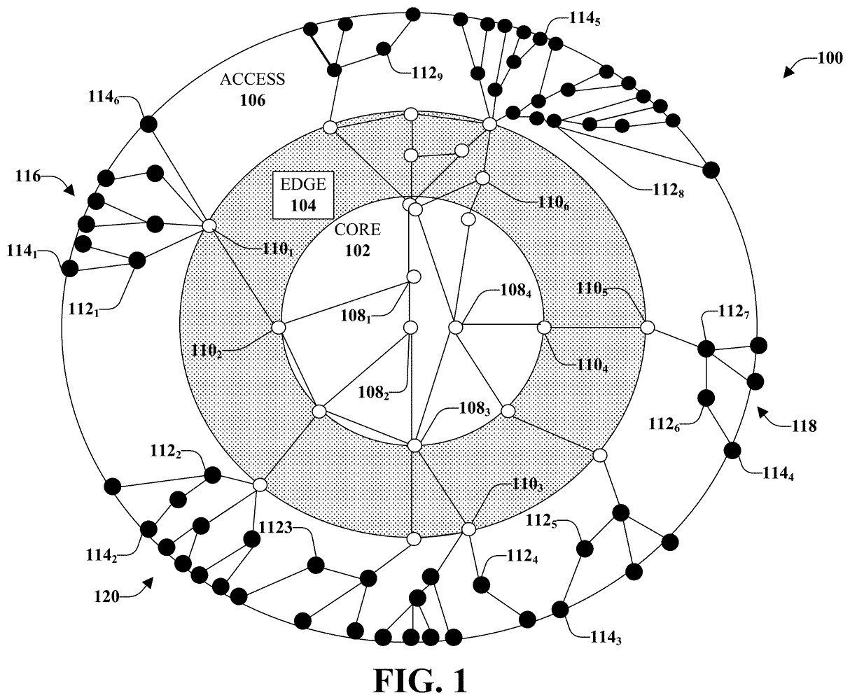

Referring initially to FIG. 1, illustrated is an example, non-limiting, simplified portion of a service provider network 100. The service provider network 100 is composed of network equipment and connections that convey information. These network equipment can be divided into three broad categories, which are a core network 102, an edge network 104, and an access network 106 of the service provider network 100.

The components or network equipment of the core network 102, for purposes of describing the one or more embodiments herein, refer to the network equipment that convey information among higher order data centers, central offices, or aggregation points in the service provider network 100. The network equipment of the core network 102 can be described as the core back bone network(s). A few network equipment of the core network 102 are labeled as network equipment 108₁, 108₂, 108₃, and 108₄.

The network equipment of the edge network 104, for purposes of describing the one or more embodiments herein, refer to the network equipment that deliver network services among lower level central offices and/or access networks. A few network equipment of the edge network 104 are labeled as network equipment 110₁, 110₂, 110₃, 110₄, 110₅, and 110₆.

Further, the network equipment of the access network 106, for purposes of describing the one or more embodiments herein, refer to the network equipment that convey information or data from the central offices or aggregation points to the endpoint locations (e.g., the user equipment). A few network equipment of the access network 106 are labeled as access network equipment 112₁, 112₂, 112₃, 112₄, 112₅, 112₆, 112₇, 112₈, and 112₉. A few user equipment are labeled as user equipment 114₁, 114₂, 114₃, 114₄, 114₅, and 114₆.

Thus, the core network equipment (e.g., network equipment 108₁, 108₂, 108₃, and 108₄) convey information between edges from one geographic area to another geographic area. For example, the core network equipment can convey information from a first geographic area 116 (e.g., a first portion of a first town, a first city, a first state) to a second geographic area 118 (e.g., a second portion of a second town a second city, a second state).

The edge network equipment (e.g., network equipment 110₁, 110₂, 110₃, 110₄, 110₅, and 110₆) convey information between core and access networks in a general area (e.g., from the first geographic area 116 to a third geographic area 120). The access network equipment (e.g., access network equipment 112₁, 112₂, 112₃, 112₄, 112₅, 112₆, 112₇, and 112₈, and 112₉) convey information between edge and endpoint locations (e.g., user equipment 114₁, 114₂, 114₃, 114₄, 114₅, and 114₆) in a given geographical area (e.g., between user equipment 114₁ and 114₆). Any of these three broad categories of service provider networks can employ permanently established network paths and/or transient network paths.

By way of example and not limitation, a communication (e.g., one or more packets, one or more signals, and so on) can be initiated at a first device (e.g., user equipment 114₁) and can be received at a second device (e.g., user equipment 114₄). The path from the first device to the second device can include one or more access network equipment (e.g., 112₁). After traversing the access network, the communication can be routed through one or more edge network equipment (e.g., 110₁ and 110₂). After being successfully routed through the edge network equipment, the communication can traverse through the core network via one or more network equipment (e.g., 108₁, 108₂, 108₃, and 108₄). Further, to be routed to its destination (e.g., the second device), the communication can be routed between one or more edge network equipment (e.g., 110₄, and 110₅) and then between one or more access network equipment (e.g., and 112₇ and 112₆) to its destination (e.g., user equipment 114₄). However, it should be understood that other routes can be taken by the communication. Further, fewer or more nodes or network equipment might be utilized to route the communication between a source device and a destination device than the number shown and described.

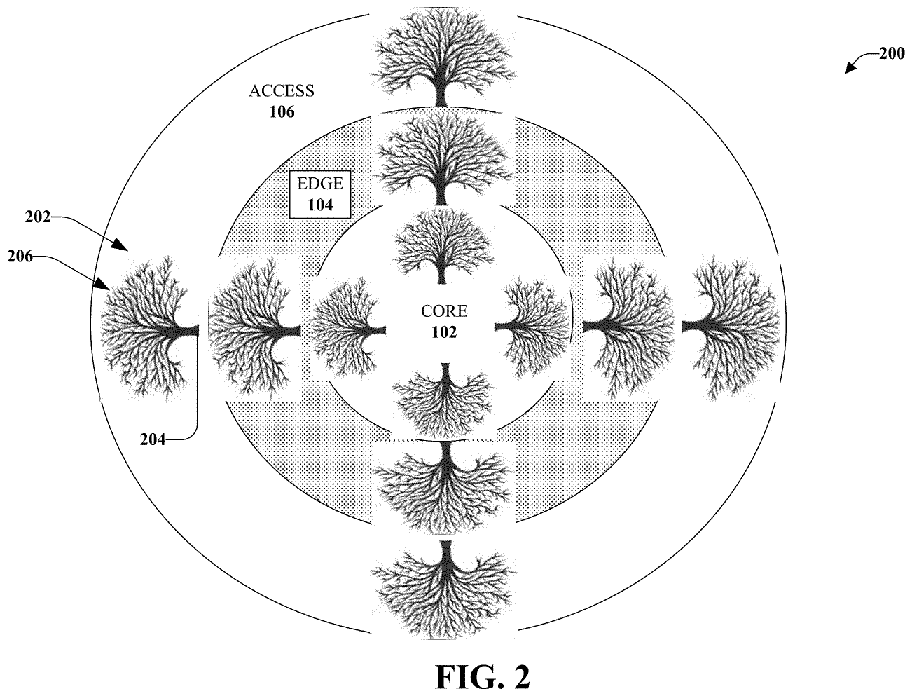

FIG. 2 illustrates an example, non-limiting, simplified portion of a service provider network 200 represented as a tree architecture. For each endpoint, there is a set of access networking devices used to deliver services (e.g., core network equipment, edge network equipment, and access network equipment). Considering a group of endpoints in a geographical region, the provider's access network devices form a tree (e.g., tree 202), where the root of the tree (e.g., root 204) is the central office or aggregation point (demarcation between provider edge network in that geographic area and the provider access networks in that particular geographic area), and the leaves (e.g., leaves 206) of the tree are the endpoints. Other nodes in the tree architecture represent the network equipment used to deliver services from the root to the leaves, and a path from the root to a leaf defines the service path used to deliver services to an endpoint (or user equipment).

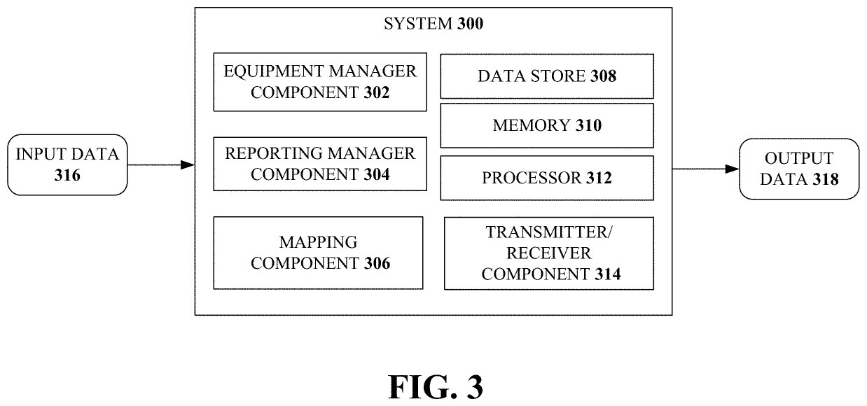

FIG. 3 illustrates an example, non-limiting, system that facilitates fault detection in core, edge, and access networks in accordance with one or more embodiments described herein. Aspects of systems (e.g., the system 300 and the like), apparatuses, and/or processes (e.g., computer-implemented methods) explained in this disclosure can include machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described. In various embodiments, the system 300 can be any type of component, machine, device, facility, apparatus, and/or instrument that can include a processor and/or can be capable of effective and/or operative communication with a wired and/or wireless network.

The various embodiments provided herein can be configured to identify network equipment failures without relying on expensive alarm management systems to monitor and report, often myopic, network alarms. The various embodiments work with traditional and virtual networks, employ parallel processing and distributed hardware for enterprise level deployments, and can operate (or function) across access, edge, and core networks of a service provider. As service providers continue to drive toward network virtualization and software defined networking, the disclosed embodiments can free providers from relying on separate ecosystems of alarming infrastructure to identify root causes of failed components (e.g., network equipment) in a network.

The system 300 can include an equipment manager component 302, a reporting manager component 304, a mapping component 306, at least one data store 308, at least one memory 310, at least one processor 312, and a transmitter/receiver component 314. In various embodiments, one or more of the equipment manager component 302, the reporting manager component 304, the mapping component 306, the at least one data store 308, the at least one memory 310, the at least one processor 312, and the transmitter/receiver component 314 can be electrically and/or communicatively coupled to one another to perform one or more of the functions of the system 300. In some embodiments, one or more of the equipment manager component 302, the reporting manager component 304, the mapping component 306, and the transmitter/receiver component 314 include software instructions stored on the at least one memory 310 and/or the at least one data store 308 and executed by the at least one processor 312. The system 300 may also interact with other hardware and/or software components not depicted in FIG. 3.

The equipment manager component 302 can track the core, edge, and access network infrastructure as it is configured for each endpoint to provide services to those endpoints. For example, the configuration for each endpoint can be stored in the at least one data store 308 (or another data store). The at least one data store 308 maintains information on each network equipment and/or endpoint. Such information can include connections between each network equipment other devices (e.g., other network equipment, user equipment, and so on). The at least one data store 308 can return (e.g., based on a request for the information) a tree of network equipment that are delivering services for a list of endpoints (e.g., one or more identified endpoints). The at least one data store 308 can also return a list of endpoints served by a network equipment (or more than one network equipment).

The reporting manager component 304 can receive and log one or more endpoint trouble reports (e.g., from user equipment, from network equipment, and so on). The endpoint trouble reports can be received as input data 316 (e.g., via the transmitter/receiver component 314). For example, the reporting manager component 304 can track the endpoint trouble reports as the one or more reports (or information representative of the reports) are received at the reporting manager component 304 (e.g., via the transmitter/receiver component 314).

The mapping component 306 can connect (e.g., map, link, or cross reference) network equipment infrastructure data with the endpoint trouble reports. The mapping component 306 can recover the tree of network equipment between an aggregation point (e.g. central office or data center) and a group of endpoints utilized to deliver services to the user equipment, whether the link or route is permanently established or transient in nature.

Information indicative of the one or more network equipment that is the cause of the endpoint trouble report can be output, as output data 318. For example, the output data 318 can include information related to the network equipment. In another example, the output data 318 can include instructions to be implemented at the one or more equipment in order to resolve the fault. For example, the instructions can include an indication for the one or more equipment to cycle power (e.g., turn off and on, or restart). In another example, the instruction can include an indication for the one or more equipment to run a diagnostics to determine the cause of the fault. In another example, the output data 318 can include a software upgrade that can be pushed to the one or more equipment and implemented (e.g., executed) by the one or more equipment. In another example, the output data can include another type of upgrade that can be executed by the equipment. In yet another example, the output data 318 can include information related to a hardware change and/or update to be implemented with respect to the equipment.

It is noted that endpoint (also referred to as customer), is a broad term indicating the endpoint or leaf of a network structure (e.g., user equipment, intermediary network equipment, and so on). The term endpoint not limited to a literal business or individual consumer of the network. To some degree, the endpoint can be a sensor or indication of service or no service, even a service provider network demarcation device. An edge network equipment is an endpoint to a connecting core network component and an access component is an endpoint to a connecting edge network component. As such, the network device tree can be applied at the start of any of the three broad networks in a geographical area.

In some cases, the physical distinction among a provider's core, edge, and access networks is diminishing through network virtualization and software defined networking. Smaller provider networks might only encompass one or two of these categories. The system 300 can account for this evolution and is agnostic with regard to physical or virtual networks in and among core, edge, and access networks. Each category, or portion thereof, can be virtualized. Further, the system 300 system does not rely on three discrete network categories to perform the localization of faults in core, edge, and/or access networks.

With continuing reference to FIG. 3, the transmitter/receiver component 314 can receive from network equipment (not shown), another apparatus (not shown), and/or another system (not shown) and/or user equipment (not shown) information indicative of a fault experienced by one or more endpoints. Further, the transmitter/receiver component 314 can output (e.g., as the output data 318) information indicative of one or more network equipment responsible for the fault. Additionally, the transmitter/receiver component 314 can output (e.g., as the output data 318) information indicative of a solution to the fault, wherein the solution can be dynamically implemented by the system 300, implemented autonomously by the network equipment, and/or implemented manually at the network equipment.

The at least one memory 310 can be operatively connected to the at least one processor 312. The at least one memory 310 and/or the at least one data store 308 can store executable instructions that, when executed by the at least one processor 312 can facilitate performance of operations. Further, the at least one processor 312 can be utilized to execute computer executable components stored in the at least one memory 310 and/or the at least one data store 308.

For example, the at least one memory 310 can store protocols associated with localizing one or more faults detected at one or more of a core network, an edge network, and an access network. Further, the at least one memory 310 can facilitate action to control communication between the system 300, other apparatuses, other systems, network equipment, and/or user equipment associated with the network(s) under consideration, and so on, such that the system 300 can employ stored protocols and/or processes to facilitate localization of faults in communications networks, including legacy networks (including telephone networks) and/or advanced networks as described herein.

It should be appreciated that data stores (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically Programmable ROM (EPROM), Electrically Erasable ROM (EEPROM), or flash memory. Volatile memory can include Random Access Memory (RAM), which acts as external cache memory. By way of example and not limitation, RAM is available in many forms such as Synchronous RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DRRAM). Memory of the disclosed aspects are intended to include, without being limited to, these and other suitable types of memory.

The at least one processor 312 can facilitate respective analysis of information related to fault detection, fault isolation, and implementation of one or more actions to resolve the one or more faults as discussed herein. The at least one processor 312 can be a processor dedicated to analyzing and/or generating information received, a processor that controls one or more components of the system 300, and/or a processor that both analyzes and generates information received and controls one or more components of the system 300.

Methods that can be implemented in accordance with the disclosed subject matter, will be better appreciated with reference to the illustrated flow charts. While, for purposes of simplicity of explanation, the methods are shown and described as a series of blocks, it is to be understood and appreciated that the disclosed aspects are not limited by the number or order of blocks, as some blocks can occur in different orders and/or at substantially the same time with other blocks from what is depicted and described herein. Moreover, not all illustrated blocks can be required to implement the disclosed methods. It is to be appreciated that the functionality associated with the blocks can be implemented by software, hardware, a combination thereof, or any other suitable means (e.g. device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

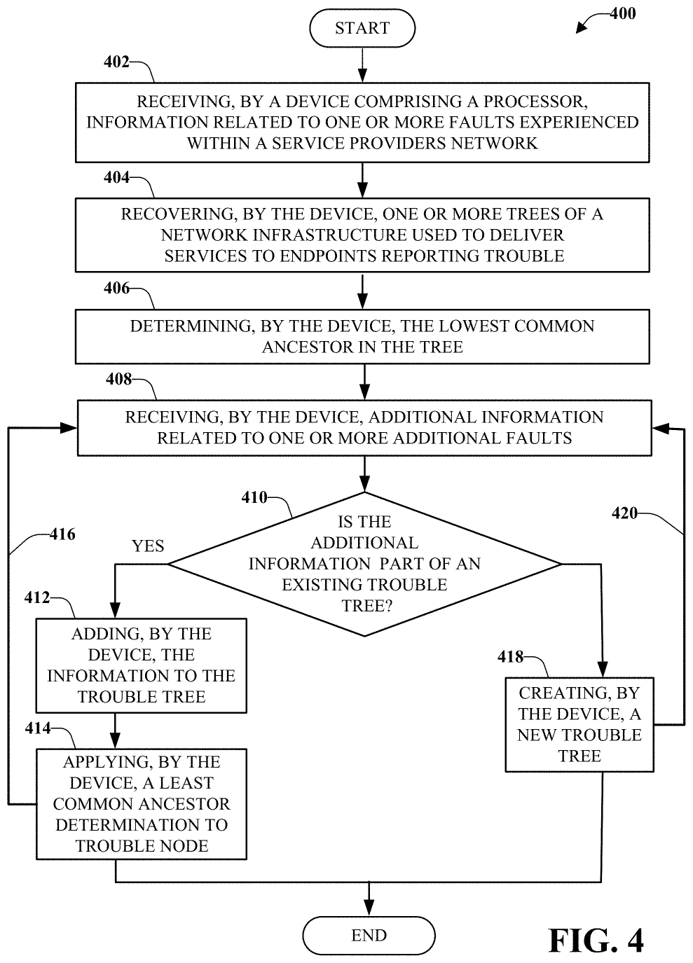

FIG. 4 illustrates an example, non-limiting, computer-implemented method 400 for localizing faults having a single failure point in accordance with one or more embodiments described herein. The computer-implemented method 400 can be implemented by a system including a processor (e.g., the system 300), network equipment including a processor, or another computer-implemented device including a processor.

The computer-implemented method 400 is related to a case of a network failure in which network equipment fails, affecting a group of endpoints and some (but not all) of those endpoints report trouble to the provider. The computer-implemented method 400 starts at 402 when information related to one or more faults experienced within a service provider's network are received. The information can be received as input data. Further, the input data can be received from a device (e.g., endpoint, user equipment) experiencing the fault. In another example, the input data can be received via another device (e.g., the device experiencing the fault is not able to report information).

At 404, one or more trees (e.g., trouble trees) of a network infrastructure used to deliver services to endpoints reporting trouble are recovered. Each node in a tree represents a network infrastructure device used to deliver services to that endpoint (e.g., leaf nodes). All endpoints (reporting and not reporting) whose services are delivered by implicated network devices are included in the trouble tree.

The lowest common ancestor in the tree is determined, at 406. The lowest common ancestor is the deepest node in the tree that is a parent node of all the endpoints reporting trouble. Given a trouble tree, the objective is to identify the most likely source of an outage for endpoints. The intuition for lowest common ancestor is that the device most associated with reported customer troubles is the best device to start investigating. The trouble tree is persisted in the system until the endpoint failure reports are closed. As additional endpoint trouble reports arrive and as other reports are closed in the trouble tree, node weights are adjusted.

For example, at 408, additional reports related to one or more faults (which can be the same faults or different faults) are received from endpoints (e.g., one or more new endpoint trouble reports). At 410, a determination is made whether the additional information (e.g., an endpoint trouble report) is part of an existing trouble tree being tracked. If yes, at 412, the information is added to the tree. For example, the information can include information indicative of a location of an endpoint experiencing trouble or other identifying information associated with the endpoints experiencing trouble. Further, at 414, a least common ancestor determination is applied to trouble node. The method can end, or can return to 408 via feedback loop 416 and one or more subsequent faults can be received.

Alternatively, if the determination at 410 is that the additional information is not part of the existing trouble tree (“NO”), at 418, a new trouble tree is created. The method can end, or can return to 408 via feedback loop 420 and one or more subsequent faults can be received. It is to be understood that the feedback loop 416 and/or the feedback loop 420 can be recursive, such that any number of subsequent reports can be received over time.

According to some implementations, a shared memory architecture for persisting trouble trees can be utilized. Further, trouble tree processing (adding nodes to the tree, and applying least common ancestor) can be distributed. This allows the trouble tree processing to run at a scale suitable to large network service providers (e g, millions of customers).

For example, the network of FIG. 1 represents only a portion of an entire network (e.g., a portion of a city) and there can be dozens of networks that represent an entire city, and hundreds of networks that represent a county, and still further networks that represent a state, and so on. Further, there can be tens or thousands, or more, nodes in each network. Since processing such a large amount of data is not possible in terms of computing capability and efficiency, the different networks (or portions thereof) are distributed among multiple devices (e.g., multiple systems, such as the system 300). Further, a problem in one city or other geographic area might not have a connection with another problem in another city or other geographic area. Thus, the distributed processing allows fault isolation to be discrete to each geographic area.

At times, however, it might be useful to relate faults across networks. For example, there are four regions and each region is implemented separately among different systems (e.g., the system 300). However, within the parallel processing (e.g., processing the four regions separately), the different sections still have a relationship or connection with each other. Thus, a connection point between the distributed processes (e.g., in the edge area) might be causing a problem for a group of endpoints, where a large percentage of the endpoints are reporting a problem. Thus, in some cases the messages (e.g., faults) should be connected across the distributed computing sessions. This is because a problem in the edge network can be causing a problem in multiple portions of the access network. Thus, the multiple systems should be able to connect to one another and share information related to the connections (or branches) across the network.

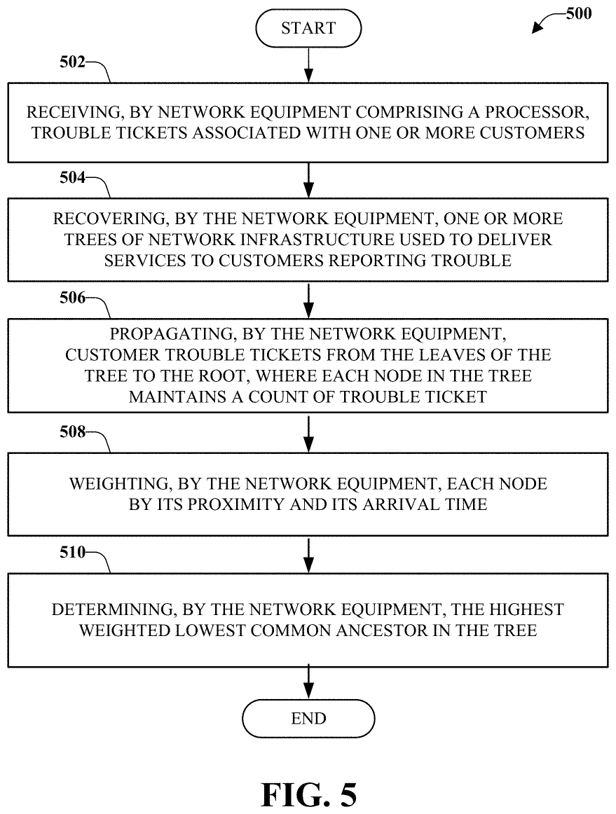

FIG. 5 illustrates an example, non-limiting, computer-implemented method 500 for using trouble report metadata for improving trouble localization in accordance with one or more embodiments described herein. The computer-implemented method 500 can be implemented by a system including a processor (e.g., the system 300), network equipment including a processor, or another computer-implemented device including a processor.

The ability to localize trouble depends on the number of endpoints reporting trouble. Too few trouble reports from endpoints not reporting or not enough time taken to collect trouble reports leads the algorithm to produce solutions too localized to the few reporting endpoints. Additionally, if multiple failures are present in a trouble tree, the trouble is localized to the node common to both problems. The former problem is addressed through threshold values supplied by the service provider: the minimum number of trouble reports needed to engage a trouble tree analysis and the maximum wait time to engage a least common ancestor on a trouble tree. The latter problem is addressed using a few possibilities chosen by the service provider. A first possibility is the recency of nodes in the tree, where trouble reports are clustered by their arrival times and separate trouble trees are created for each cluster. Another possibility is the proximity of trouble reports. In this case, cluster trouble reports are clustered by their proximity in the trouble tree and separate trouble trees are created for each cluster. Yet another possibility is weighting by proximity and recency. For example, in cases where the network is established and static, solutions closest to customers can be preferred. Weighting by proximity and recency uses an additional pass through the trouble tree. The proposed embodiments weights each node by their trouble counts, adjusted by their proximity and/or recency in the network.

The computer-implemented method 500 starts at 502, when trouble tickets associated with one or more customers are received. One or more trees of network infrastructure used to deliver services to customers reporting trouble are recovered, at 504. Each node in a tree represents a network infrastructure device (e.g., network equipment) used to deliver services to that customer (leaf nodes). All customers (reporting and not reporting) whose services are delivered by implicated network devices are included in the trouble tree.

Further, at 506, customer trouble tickets are propagated from the leaves of the tree to the root, where each node in the tree maintains a count of trouble tickets. Each increment in trouble count for a node represents the number of trouble tickets reported on services delivered by that device. Once complete, each node has a weight, which is the number of tickets reported on services delivered by that device.

At 508, each node is weighted (w) additionally by its proximity (1/# (one divided by the number) of edges to next closest non-zero weighted node) p and its arrival time (1/s where s is the seconds since arrival) w′=w*p*s. The arrival time is based on receipt of the trouble ticket for that node. Further, at 510, the highest weighted lowest common ancestor in the tree is determined. The highest weighted lowest common ancestor is identified as the node that is causing the faults experienced in the network.

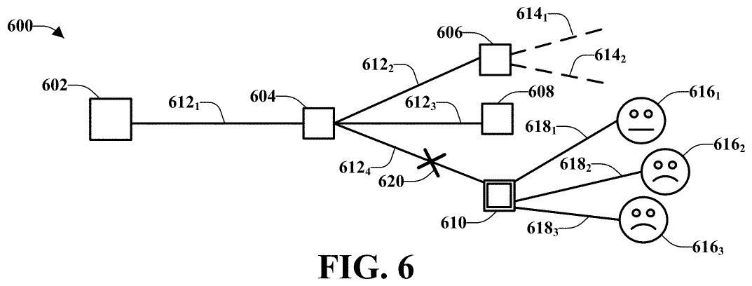

FIG. 6 illustrates an example, non-limiting, schematic representation of a network architecture 600 in accordance with one or more embodiments described herein. For simplicity purposes, the various networks and network architectures are discussed as a static paths or static branches. However, the branches can be dynamic, transient, or another type of branch. The network architecture 600 can be part of the access network, part of the core network, part of the edge network, or can represent all three networks. For purposes of explanation, the network architecture will be described as being part of the access network.

A central office node 602 provides services to one or more customers (e.g., user equipment for this example), via one or more nodes, illustrated as a first node 604, a second node 606, a third node 608, an a fourth node 610. The path between the central office node 604 and the end user (e.g., customer) can include multiple branches. The branch between the central office node 602 and the first node 604 is a first branch 612₁. The branch between the first node 604 and the second node 606 represents a second branch 612₂. The second node 606 can provide services via one or more branch (e.g., first branch 614₁ and second branch 614₂) to one or more customers (not illustrated). The branch between the first node 604 and the third node 608 represents a third branch 612₃. The third node 608 can provide services via one or more branch (not illustrated) to one or more customers (not illustrated). Further, the branch between the first node 604 and the fourth node 610 represents a fourth branch 612₄. The fourth node 610 can provide services via one or more branch to one or more customers. For example, the fourth node 610 provides first services to a first leaf or first customer 616₁ via a first branch 618₁, second services to a second leaf or second customer 616₂ via a second branch 618₂, and third services to a third leaf or third customer 616₃ via a third branch 618₃. The services can be provided by wireline branches, wireless branches, or a combination of wireline and wireless branches.

For purposes of this example, the first customer 616₁ is not aware of a problem (e.g., user equipment is not in use). However, it has been determined that the second customer 616₂ and the third customer 616₂ are experiencing problems. Such problems can be reported to the central office node 602. In an example, a user can report a problem with their respective user equipment. In another example, one or more other devices report a problem. In yet another example, the endpoint provides pings (e.g., heartbeat messages) that indicate the endpoint is okay. Thus, not receiving the ping (or heartbeat message) can indicate a problem with the endpoint.

It is noted that the one or more customers serviced via the second node 606 and the third node 608 are not experiencing problems. Thus, the least common ancestor associated with the second customer 616₂ and the third customer 616₃ is the fourth node 610. Accordingly, a problem exists after the first node 604 and is indicated by the impacted branch of the LCA node 620 (e.g., the X). Accordingly, the fourth branch 612₄ is the impacted branch of the least common ancestor node (e.g., the fourth node 610). The first node 604 is ruled out as being the least common ancestor in this example because the one or more customers associated with the second node 606 and the third node 608 are not experiencing problems. If the first node 604 were the problem, one or more customer of the second node and/or the third node 608 would report a problem.

If only one customer (e.g., the second customer 616₂) were determined to be experiencing a problem, it might be identified as a problem with the user equipment itself. Over time, however, one or more other customers (e.g., the third customer 616₃) could experience a problem. It is noted that problems might not be reported (or information indicative of the problem) might not be received at a time when the problem actually occurred because such problems might not be detected until a later time and might not be reported until still a later time. Accordingly, once it is determined that a threshold number of customers are experiencing a problem, a determination can be made as to what the customers with problems have in common. In this over simplified example, all customers have the central office node 602 and the first node 604 in common. The least common ancestor solution can be used to determine that the fourth node 610 is the least common ancestor to the customers that are experiencing problems in the above example. Thus, the system will pinpoint the fourth node 610 as being a problem since it is a common point for the customers experiencing problems. In this example, it is two out of three customers reporting a problem. However, in various use cases, it can be five out of one hundred customers, or fifteen out of two hundred customers, or another percentage of customers.

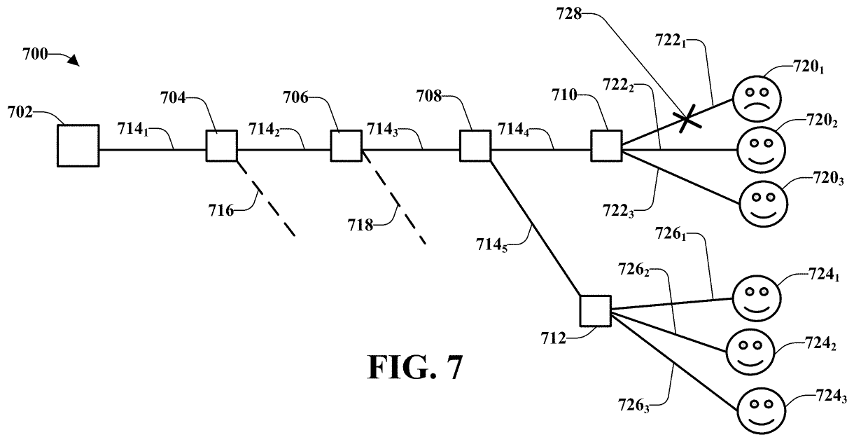

FIG. 7 illustrates another example, non-limiting, schematic representation of a network architecture 700 in accordance with one or more embodiments described herein. For simplicity purposes, the various networks and network architectures are discussed as a static path. However, the paths can be dynamic, transient, or another type of path. The network architecture 700 can be part of the access network, part of the core network, part of the edge network, or can represent all three networks. For purposes of explanation, the network architecture will be described as being part of the access network.

Illustrated are a central office node 702, a first node 704, a second node 706, a third node 708, a fourth node 710, and a fifth node 712. The branch between the central office node 702 and the first node 704 is a first branch 714₁. The branch between the first node 704 and the second node 706 represents a second branch 714₂. The second node 706 can provide services to one or more customers (not illustrated) via one or more branches (e.g., branch 716). The branch between the second node 706 and the third node 708 represents a third branch 714₃. The branch between the third node 708 and the fourth node 710 represents a fourth branch 714₄. The branch between the third node 708 and the fifth node 712 represents a fifth branch 714₅. The fourth node 710 provides first services to a first customer 720₁ via a first branch 722₁, second services to a second customer 720₂ via a second branch 722₂, and third services to a third customer 720₃ via a third branch 722₃. Further, the fifth node 712 provides first services to a first customer 724₁ via a first branch 726₁, second services to a second customer 724₂ via a second branch 726₂, and third services to a third customer 724₃ via a third branch 726₃.

In a first example, it is determined that the first customer 720₁ is experiencing a communication failure. However, neither the second customer 720₂ nor the third customer 720₃ is experiencing communication failures. Therefore, it can be determined that the failure is on a first path 722₁, as indicated by the impacted branch of the LCA node 728 (e.g., the X), which can be an individual or singular problem. In this case, the number of customers reporting a problem is a single customer and, therefore, does not satisfy a defined threshold number of customers that are experiencing a problem.

If one or more of the three customers associated with the fourth node 710 are in trouble, but the customers associated with the fifth node 712 are not in trouble, it indicates a problem with the fourth node 710, or the link between the third node 708 and the fourth node 710.

In a second example, it is determined that the first customer 720₁, the third customer 720₃, and the second customer 724₂ are experiencing respective communication failures. In this case, the number of customers experiencing a failure satisfies a threshold level and, thus, a determination can be made as to the least common ancestor for the customers. In this case, neither the fourth node 710 nor the fifth node 712 are the least common ancestor because the customers experiencing failures do not have these nodes in common. Thus, it can be determined that the communication failure is at the third node 708. It is noted that customers of the first node 704 and customers of the second node 706 are not experiencing communication failures in this example.

If either set of customers (customers of the first node 704 and customers of the second node 706) are experiencing communication failures, and such failures satisfy a threshold related to recency, it can indicate a problem closer to the central office node 702, or at the central office node 702 itself.

According to an implementation, the customers can be classified as Internet of Things (IOT) devices that stream data (e.g., continual streaming, constant streaming, streaming at defined times, streaming at random times, streaming based on detection of an event, streaming based on status change or another change, and so on) or positively report information to a network, such as a Radio Access Network (RAN).

Further, in some implementations, at least the fourth node 710 and the fifth node 712 can be access points (e.g., radio tower, cell tower, base station, and so on) and the customers are in wireless communication with the fourth node 710 and the fifth node 712. In these implementations, the fourth node 710 and the fifth node 712 can be considered “customers” for a wireline connection (e.g., backhaul) with the third node 708.

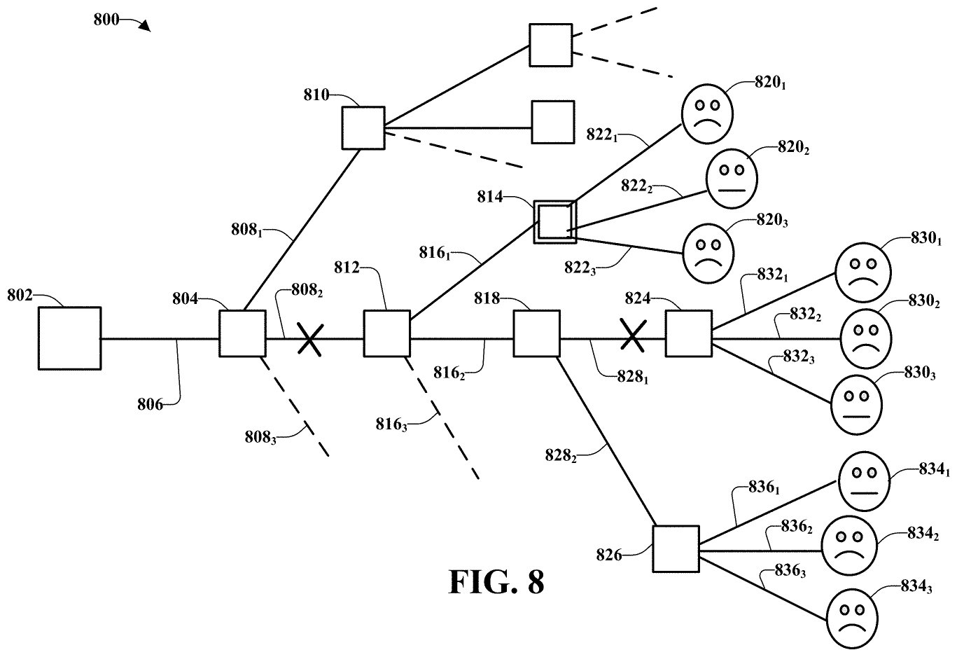

FIG. 8 illustrates another example, non-limiting, schematic representation of a network architecture 800 for root cause interference in accordance with one or more embodiments described herein. For simplicity purposes, the various networks and network architectures are discussed as a static path. However, the paths can be dynamic, transient, or another type of path. The network architecture 800 can be part of the access network, part of the core network, part of the edge network, or can represent all three networks. For purposes of explanation, the network architecture will be described as being part of the access network.

Illustrated are a central office node 802 communicatively coupled (e.g., connected) to a first node 804 via a first branch 806. The first node 804 has three branches, illustrated as a first branch 808₁, a second branch 808₂, and a third branch 808₃. The first node 804 is connected to a second node 810 via the first branch 808₁ and to a third node 812 via the second branch 808₂. The first node 804 is also connected to at least one other node (not shown) via the third branch 808₃, which for purposes of explanation are not currently experiencing faults. The second node 810 is connected to one or more other nodes, which for purposes of explanation are not currently experiencing faults.

The third node 812 is connected to a fourth node 814 via a first branch 816₁, to a fifth node 818 via a second branch 816₂, and to one or more other nodes (not illustrated) via a third branch 816₃. The fourth node 814 is connected to three customers, illustrated as a first customer 820₁, a second customer 820₂, and a third customer 820₃, via respective branches 822₁, 822₂, and 822₃.

The fifth node 818 is connected to a sixth node 824 and a seventh node 826 via respective branches 828₁ and 828₂. The sixth node 824 is connected to three customers, illustrated as customer one 830₁, customer two 830₂, and customer three 830₃, via respective branches 832₁, 832₂, and 832₃. Further, as illustrated, the seventh node 826 is connected to three customers, illustrated as 1^{st} customer 834₁, 2^{nd} customer 834₂, and 3^{rd} customer 834₃, via respective branches 836₁, 836₂, and 836₃.

In this case, respective information indicative of faults have been received and, overtime, additional information indicative of additional faults can be received. For example, initially, information indicative of a fault experienced by customer one 830₁ and customer two 830₂ is received. Based on this information, it can initially be determined that the least common ancestor is the sixth node 824.

However, over time additional faults are determined to be experienced by the 2^{nd} customer 834₂ and the 3^{rd} customer 834₃. If the fault experienced by customer one 830₁ and customer two 830₂ has not been corrected and removed from consideration, the newly discovered faults can be considered to be related to the previous faults. Thus, an updated least common ancestor can be determined to be the fifth node 818.

Continuing this example, further information indicative of faults being experienced by the first customer 820₁ and the third customer 820₃ are received. Thus, based on the above noted faults not being corrected and removed from consideration, and based on a recency associated with these faults, the least common ancestor can be updated to be, for example, the third node 812. Thus, based on the additional customers upstream indicating faults, the determination of the least common ancestor can be updated in order to pinpoint the problem. The time between the faults can be a defined recency time (e.g., five seconds, three minutes, four hours, and so on) depending on the services being provided.

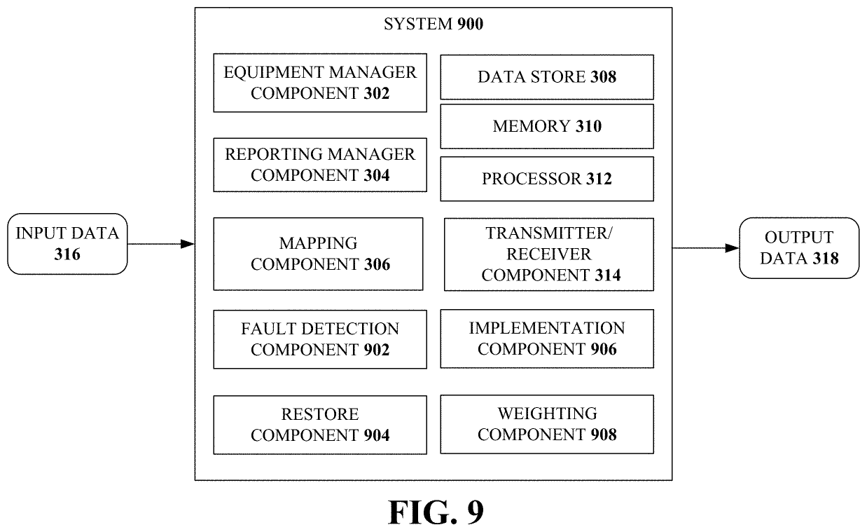

FIG. 9 illustrates an example, non-limiting, system 900 for localizing faults in a communications network in accordance with one or more embodiments described herein. Repetitive description of like elements employed in other embodiments described herein is omitted for sake of brevity.

A fault detection component 902 can determine that a fault exists in a group of communication paths between a root network node and a leaf network node. For example, the determination by the fault detection component 902 can be based on information indicative of one or more faults received at the reporting manager component 304.

Based on the determination by the fault detection component 902 that at least one fault exists, a restore component 904 can establish a restoration of a group of communication paths of a network infrastructure that includes network nodes between the root network node and the leaf network node. For example, the restore component 904 can receive data indicative of at least a portion of at least one of an edge network, a core network, and/or an access network.

According to some implementations, the restore component 904 can restructure transient portions of the group of communications paths. For example, the transient portions are associated with a software defined network. Such restructuring can be based on restricting a multitude of network paths that can be created to establish a link of network nodes between the root network node and the leaf network nodes.

Based on the restoration of the group of communication paths, the mapping component 306 can determine that a defined network node of the network nodes is a source of the fault based on respective positions of user equipment experiencing the fault relative to the defined network node. According to some implementations, the determination by the mapping component 306 can be based on the respective positions of the user equipment are represented along a communication path. Further, the determination by the mapping component 306 can be that the defined network node is the closest node to the user equipment experiencing the fault.

In some implementations, the determination by the mapping component 306 can include determining that first communication paths and second communication paths of the group of communication paths diverge at the defined network node.

It is noted that other nodes, other than the root network node and the leaf network node, which are located between the defined network node and the user equipment, are determined by the mapping component 306 not to be common to the user equipment experiencing the fault. Thus, the other nodes can be eliminated as being a source of the fault.

An implementation component 906 can be configured to implement one or more actions to remove the fault. For example, the implementation component 906 can control a functionality of the defined network node, identified as the cause of the fault. For example, the implementation component 906 can instruct the defined network node to execute a diagnostics to determine the cause of the fault. In another example, the implementation component 906 can push a software upgrade to the defined network node, which can be executed. According to another example, the implementation component 906 can provide instructions to the defined network node to cycle power (e.g., restart). In another example, the implementation component 906 can provide instructions related to one or more hardware updates that should be performed with respect to the defined network node.

In some implementations, a weighting component 908 can apply respective weights to the network nodes based on respective proximities of the network nodes to the user equipment and based on respective arrival times of information indicative of the fault. Further to these implementations, the mapping component 306 can identify the defined network node based on the defined network node being assigned a weight of the respective weights that is more than weights of the respective weights assigned to other network nodes (other than the defined network node).

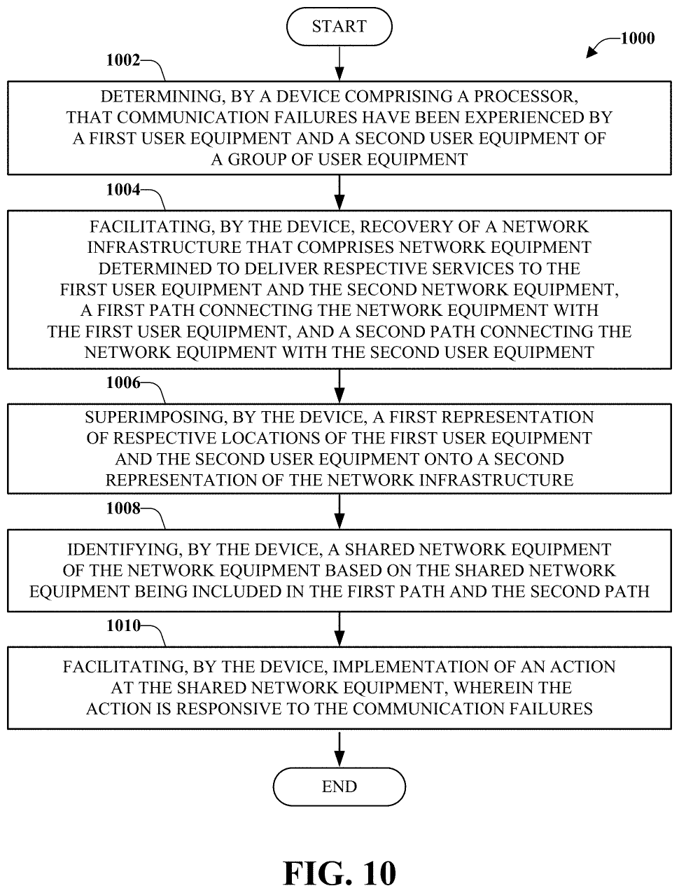

FIG. 10 illustrates an example, non-limiting, computer-implemented method 1000 for localizing faults having a single failure point in accordance with one or more embodiments described herein. The computer-implemented method 1000 can be implemented by a system including a processor (e.g., the system 300, the system 900), network equipment including a processor, or another computer-implemented device including a processor.

It is noted that although some embodiments are discussed with respect to a single failure point, the disclosed embodiments can be configured to define more than one failure point using the same or similar functionality. At 1002, it is determined that communication failures have been experienced by a first user equipment and a second user equipment of a group of user equipment. For example, the determination can be based on receiving information indicative of the one or more faults. For example, first information indicative of a first fault at a first device, second information indicative of a second fault at a second device, and subsequent information indicative of subsequent faults at subsequent devices can be received. The fault information can be received at different times since devices might experience and/or report faults at different times depending on the services executing on the device, the frequency of usage of the device, and other considerations.

At 1004, the computer-implemented method 1000 can facilitate recovery of a network infrastructure. The network infrastructure can include network equipment determined to deliver respective services to the first user equipment and the second network equipment. Further, the network infrastructure can include a first path (e.g., branch) connecting the network equipment with the first user equipment and a second path (e.g., branch) connecting the network equipment with the second user equipment (and/or subsequent paths of subsequent equipment). According to some implementations, facilitating the recovery of the network infrastructure can include recreating transient portions of the first path. The transient portions can be associated with a software defined network.

A first representation of respective locations of the first user equipment and the second user equipment (and/or subsequent user equipment) can be superimposed onto a second representation of the network infrastructure, at 1006. For example, the customers of FIGS. 6-8 can be included in the first representation and the nodes and branches of FIGS. 6-8 can be included in the second representation (e.g., the network infrastructure).

According to some implementations, prior to superimposing the first representation onto the second representation, a determination can be made that the network equipment further delivers services to a third user equipment. Further to these implementations, the superimposing can include superimposing a third representation of a third location of the third user equipment onto the network infrastructure, although a communication failure is not indicated at the third user equipment. However, since services are delivered to the third network equipment, the third network equipment is included in the complete network infrastructure.

At 1008, a shared network equipment of the network equipment can be identified. For example, the identification can be based on the shared network equipment being included in the first path and the second path. According to an implementation, the identification can include determining the first path and the second path are a same path. According to another implementation, the determination can include determining the first path and the second path are linked at the shared network equipment.

Further, at 1010, the method can facilitate implementation of an action at the shared network equipment. The action is responsive to the communication failures. The action can include conveying one or more instructions to the shared network equipment to resolve at least one communication failure. In an example, an instruction can be related to an action performed on the shared network equipment (e.g., by another network equipment). In another example, an instruction can be related to an action performed autonomously by the shared network equipment to resolve the communication failure (e.g., execute a diagnostics and related solution, upgrade software, revert to a previous software version, change one or more configurations, revert to a previous configuration, cycle power (e.g., restart), and so on).

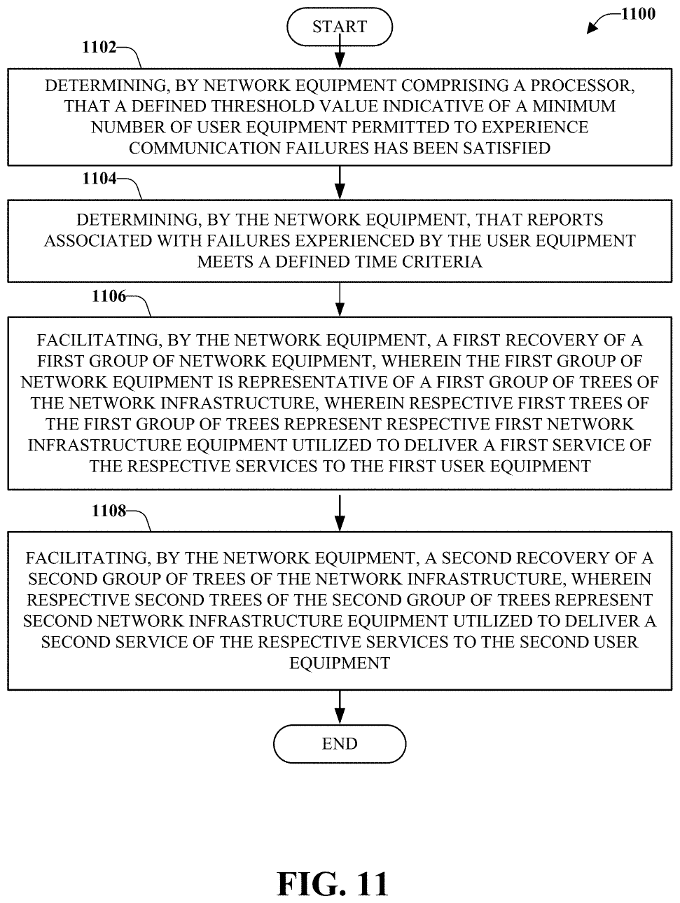

FIG. 11 illustrates an example, non-limiting, computer-implemented method 1100 for recovering a network infrastructure to localize one or more communication failures in a communications network in accordance with one or more embodiments described herein. The computer-implemented method 1100 can be implemented by a system including a processor (e.g., the system 300, the system 900), network equipment including a processor, or another computer-implemented device including a processor.

The computer-implemented method 1100 can include determining that a defined threshold value indicative of a minimum number of user equipment permitted to experience communication failures has been satisfied, at 1102. The defined threshold value can be based on the number of user equipment located within a portion of a communications network under consideration. Further, the defined threshold value can be a value that indicates the failure is not localized to a single user equipment (e.g., a problem with the user equipment itself or a connection between a serving node and the user equipment) and that the failure is shared among a group of user equipment. At 1104, the method can include determining that reports associated with failures experienced by the user equipment meets a defined time criteria (e.g., a recency). The recency relates to the reporting of failures being within a defined amount of time of one another, which can indicate a similar cause.

At 1106, the method can facilitate a first recovery of a first group of network equipment. The first group of network equipment is representative of a first group of trees of the network infrastructure. Respective first trees of the first group of trees represent respective first network infrastructure equipment utilized to deliver a first service of the respective services to the first user equipment.

Further, at 1108, the computer-implemented method 1100 can facilitate a second recovery of a second group of trees of the network infrastructure. Respective second trees of the second group of trees represent second network infrastructure equipment utilized to deliver a second service of the respective services to the second user equipment.

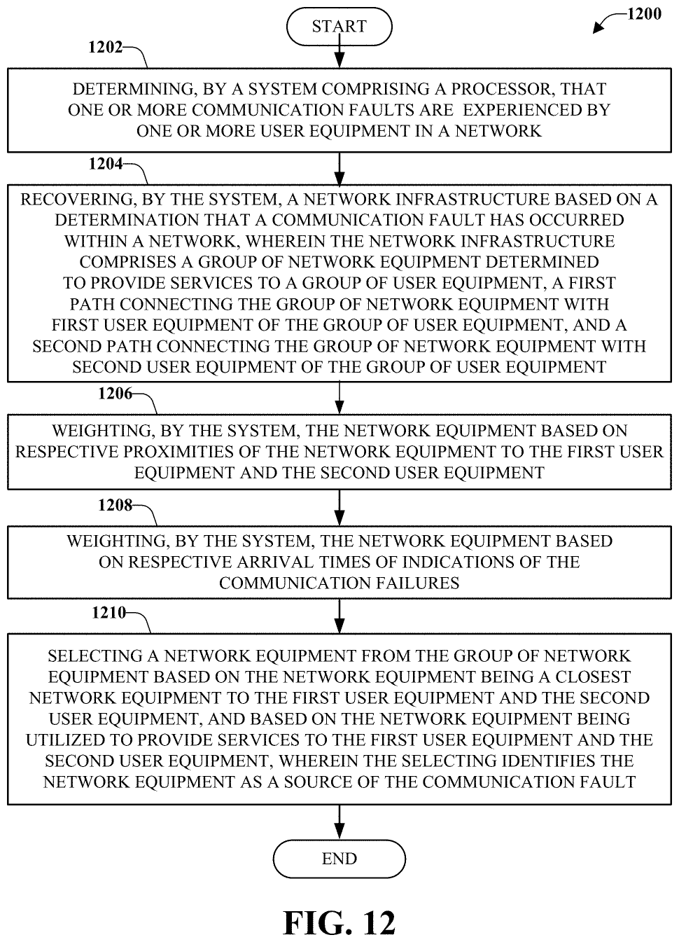

FIG. 12 illustrates an example, non-limiting, computer-implemented method 1200 for localizing a communication fault based on assigning weights to nodes in a communications network in accordance with one or more embodiments described herein. The computer-implemented method 1200 can be implemented by a system including a processor (e.g., the system 300, the system 900), network equipment including a processor, or another computer-implemented device including a processor.

At 1202, one or more communication faults in a network are determined to be experienced by one or more user equipment. The communication faults can be determined based on receiving information indicative of the failures, based on lack of communication from at least one device that provides heartbeat messages, or based on other information indicative of one or more failures.

At 1204, a network infrastructure is recovered based on a determination that the one or more communication fault has occurred within the network. The network infrastructure can include a group of network equipment determined to provide services to a group of user equipment. The network infrastructure can also include a first path connecting the group of network equipment with first user equipment of the group of user equipment and a second path connecting the group of network equipment with second user equipment of the group of user equipment.

The network equipment can be weighted, at 1206, based on respective proximities of the network equipment to the first user equipment and the second user equipment. For example, a determination can be made that a network equipment is the closest network equipment based on the network equipment being a node that routes first data via the first path to the first user equipment and second data via the second path to the second user equipment.

At 1208, the network equipment can be weighted based on respective arrival times of indications of the communication failures. Thus, the more recent an indication of the communication failure is and/or the closer in time that the indication of the communication failure is received as compared to other indications of communication failures can be given a higher weight.

A network a network equipment is selected from the group of network equipment, at 1210. The network equipment can be selected based on the network equipment being the closest network equipment to the first user equipment and the second user equipment. For example, the network equipment can be determined to be the closest network equipment based on the network equipment being a node that routes first data via the first path to the first user equipment and second data via the second path to the second user equipment.

Further, the network equipment can be selected based on the network equipment being utilized to provide services to the first user equipment and the second user equipment. The selection identifies the network equipment as a source of the communication fault.

In an example, the network equipment is a first network equipment. Further it can be determined that the first network equipment is the closest network equipment based on detection of the communication fault existing between the first network equipment and a second network equipment although the second network equipment is in a closer proximity to the first user equipment than the first network equipment.

Described herein are systems, methods, articles of manufacture, and other embodiments or implementations that can facilitate localization of faults in core, edge, and access networks. Facilitating localization of faults in core, edge, and access networks can be implemented in connection with any type of device with a connection to the communication network (e.g., a mobile handset, a computer, a handheld device, etc.) any Internet of things (IoT) device (e.g., toaster, coffee maker, blinds, music players, speakers, etc.), and/or any connected vehicles (cars, airplanes, space rockets, and/or other at least partially automated vehicles (e.g., drones)). In some embodiments, the non-limiting term User Equipment (UE) is used. It can refer to any type of wireless device that communicates with a radio network node in a cellular or mobile communication system. Examples of UE are target device, device to device (D2D) UE, machine type UE or UE capable of machine to machine (M2M) communication, PDA, Tablet, mobile terminals, smart phone, Laptop Embedded Equipped (LEE), laptop mounted equipment (LME), USB dongles etc. Note that the terms element, elements and antenna ports can be interchangeably used but carry the same meaning in this disclosure. The embodiments are applicable to single carrier as well as to Multi-Carrier (MC) or Carrier Aggregation (CA) operation of the UE. The term Carrier Aggregation (CA) is also called (e.g., interchangeably called) “multi-carrier system,” “multi-cell operation,” “multi-carrier operation,” “multi-carrier” transmission and/or reception.

The term network equipment is used herein to refer to any type of network node serving UE and/or connected to other network equipment, network nodes, network elements, or another network node from which the UEs can receive a radio signal. In cellular radio access networks (e.g., Universal Mobile Telecommunications System (UMTS) networks), network nodes can be referred to as base transceiver stations (BTS), radio base station, radio network nodes, base stations, NodeB, eNodeB (e.g., evolved NodeB), and so on. In 5G terminology, the network nodes can be referred to as gNodeB (e.g., gNB) devices. Network nodes can also include multiple antennas for performing various transmission operations (e.g., MIMO operations). A network node can include a cabinet and other protected enclosures, an antenna mast, and actual antennas. Network nodes can serve several cells, also called sectors, depending on the configuration and type of antenna. Examples of network nodes can include but are not limited to: NodeB devices, base station (BS) devices, access point (AP) devices, and radio access network (RAN) devices. The network nodes can also include Multi-Standard Radio (MSR) radio node devices, including: an MSR BS, an eNode B, a network controller, a Radio Network Controller (RNC), Base Station Controller (BSC), a relay, a donor node controlling relay, a Base Transceiver Station (BTS), an Access Point (AP), a transmission point, a transmission node, a Remote Radio Unit (RRU), a Remote Radio Head (RRH), nodes in distributed antenna system (DAS), and the like.

In some embodiments, the non-limiting term radio network node or simply network node is used. It can refer to any type of network node that serves one or more UEs and/or that is coupled to other network nodes or network elements or any radio node from where the one or more UEs receive a signal. Examples of radio network nodes are Node B, Base Station (BS), Multi-Standard Radio (MSR) node such as MSR BS, eNode B, network controller, Radio Network Controller (RNC), Base Station Controller (BSC), relay, donor node controlling relay, Base Transceiver Station (BTS), Access Point (AP), transmission points, transmission nodes, RRU, RRH, nodes in Distributed Antenna System (DAS) etc.

Cloud Radio Access Networks (RAN) can enable the implementation of concepts such as Software-Defined Network (SDN) and Network Function Virtualization (NFV) in 5G networks. This disclosure can facilitate a generic channel state information framework design for a 5G network. Certain embodiments of this disclosure can include an SDN controller that can control routing of traffic within the network and between the network and traffic destinations. The SDN controller can be merged with the 5G network architecture to enable service deliveries via open Application Programming Interfaces (APIs) and move the network core towards an all Internet Protocol (IP), cloud based, and software driven telecommunications network. The SDN controller can work with, or take the place of Policy and Charging Rules Function (PCRF) network elements so that policies such as quality of service and traffic management and routing can be synchronized and managed end to end.

To meet the huge demand for data centric applications, 4G standards can be applied to 5G, also called New Radio (NR) access. 5G networks can include the following: data rates of several tens of megabits per second supported for tens of thousands of users; 1 gigabit per second can be offered simultaneously (or concurrently) to tens of workers on the same office floor; several hundreds of thousands of simultaneous (or concurrent) connections can be supported for massive sensor deployments; spectral efficiency can be enhanced compared to 4G; improved coverage; enhanced signaling efficiency; and reduced latency compared to LTE. In multicarrier system such as OFDM, each subcarrier can occupy bandwidth (e.g., subcarrier spacing). If the carriers use the same bandwidth spacing, then it can be considered a single numerology. However, if the carriers occupy different bandwidth and/or spacing, then it can be considered a multiple numerology.

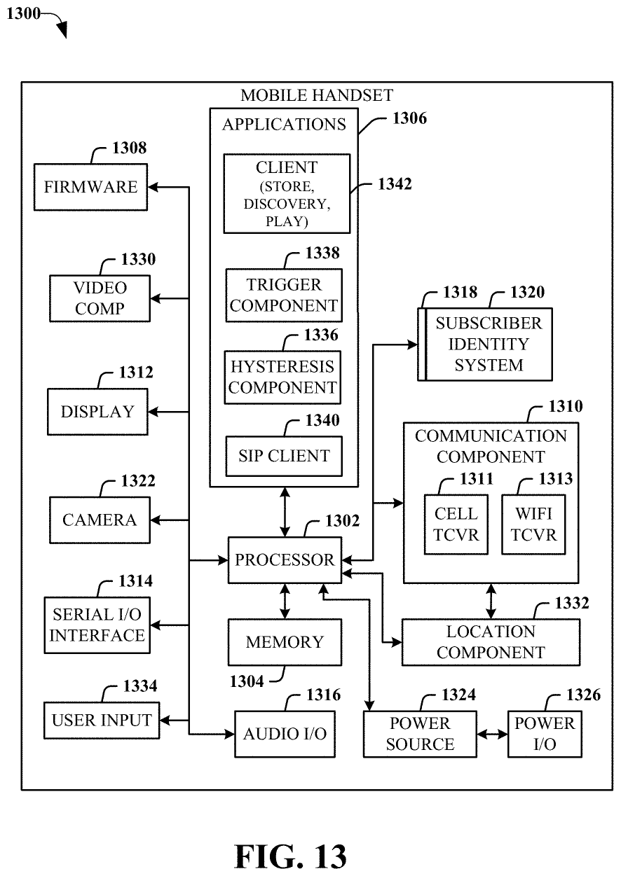

Referring now to FIG. 13, illustrated is an example, non-limiting, block diagram of a handset 1300 operable to engage in a system architecture that facilitates wireless communications according to one or more embodiments described herein. Although a mobile handset is illustrated herein, it will be understood that other devices can be a mobile device, and that the mobile handset is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset includes a processor 1302 for controlling and processing all onboard operations and functions. A memory 1304 interfaces to the processor 1302 for storage of data and one or more applications 1306 (e.g., a video player software, user feedback component software, etc.). Other applications can include voice recognition of predetermined voice commands that facilitate initiation of the user feedback signals. The applications 1306 can be stored in the memory 1304 and/or in a firmware 1308, and executed by the processor 1302 from either or both the memory 1304 or/and the firmware 1308. The firmware 1308 can also store startup code for execution in initializing the handset 1300. A communications component 1310 interfaces to the processor 1302 to facilitate wired/wireless communication with external systems, e.g., cellular networks, VoIP networks, and so on. Here, the communications component 1310 can also include a suitable cellular transceiver 1311 (e.g., a GSM transceiver) and/or an unlicensed transceiver 1313 (e.g., Wi-Fi, WiMax) for corresponding signal communications. The handset 1300 can be a device such as a cellular telephone, a PDA with mobile communications capabilities, and messaging-centric devices. The communications component 1310 also facilitates communications reception from terrestrial radio networks (e.g., broadcast), digital satellite radio networks, and Internet-based radio services networks.

The handset 1300 includes a display 1312 for displaying text, images, video, telephony functions (e.g., a Caller ID function), setup functions, and for user input. For example, the display 1312 can also be referred to as a “screen” that can accommodate the presentation of multimedia content (e.g., music metadata, messages, wallpaper, graphics, etc.). The display 1312 can also display videos and can facilitate the generation, editing and sharing of video quotes. A serial I/O interface 1314 is provided in communication with the processor 1302 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1300, for example. Audio capabilities are provided with an audio I/O component 1316, which can include a speaker for the output of audio signals related to, for example, indication that the user pressed the proper key or key combination to initiate the user feedback signal. The audio I/O component 1316 also facilitates the input of audio signals through a microphone to record data and/or telephony voice data, and for inputting voice signals for telephone conversations.

The handset 1300 can include a slot interface 1318 for accommodating a SIC (Subscriber Identity Component) in the form factor of a card Subscriber Identity Module (SIM) or universal SIM 1320, and interfacing the SIM card 1320 with the processor 1302. However, it is to be appreciated that the SIM card 1320 can be manufactured into the handset 1300, and updated by downloading data and software.

The handset 1300 can process IP data traffic through the communications component 1310 to accommodate IP traffic from an IP network such as, for example, the Internet, a corporate intranet, a home network, a person area network, etc., through an ISP or broadband cable provider. Thus, VoIP traffic can be utilized by the handset 1300 and IP-based multimedia content can be received in either an encoded or decoded format.

A video processing component 1322 (e.g., a camera) can be provided for decoding encoded multimedia content. The video processing component 1322 can aid in facilitating the generation, editing, and sharing of video quotes. The handset 1300 also includes a power source 1324 in the form of batteries and/or an AC power subsystem, which power source 1324 can interface to an external power system or charging equipment (not shown) by a power I/O component 1326.

The handset 1300 can also include a video component 1330 for processing video content received and, for recording and transmitting video content. For example, the video component 1330 can facilitate the generation, editing and sharing of video quotes. A location tracking component 1332 facilitates geographically locating the handset 1300. As described hereinabove, this can occur when the user initiates the feedback signal automatically or manually. A user input component 1334 facilitates the user initiating the quality feedback signal. The user input component 1334 can also facilitate the generation, editing and sharing of video quotes. The user input component 1334 can include such conventional input device technologies such as a keypad, keyboard, mouse, stylus pen, and/or touchscreen, for example.

Referring again to the applications 1306, a hysteresis component 1336 facilitates the analysis and processing of hysteresis data, which is utilized to determine when to associate with the access point. A software trigger component 1338 can be provided that facilitates triggering of the hysteresis component 1336 when the Wi-Fi transceiver 1313 detects the beacon of the access point. A SIP client 1340 enables the handset 1300 to support SIP protocols and register the subscriber with the SIP registrar server. The applications 1306 can also include a client 1342 that provides at least the capability of discovery, play and store of multimedia content, for example, music.

The handset 1300, as indicated above related to the communications component 1310, includes an indoor network radio transceiver 1313 (e.g., Wi-Fi transceiver). This function supports the indoor radio link, such as IEEE 802.11, for a dual-mode GSM handset. The handset 1300 can accommodate at least satellite radio services through a handset that can combine wireless voice and digital radio chipsets into a single handheld device.

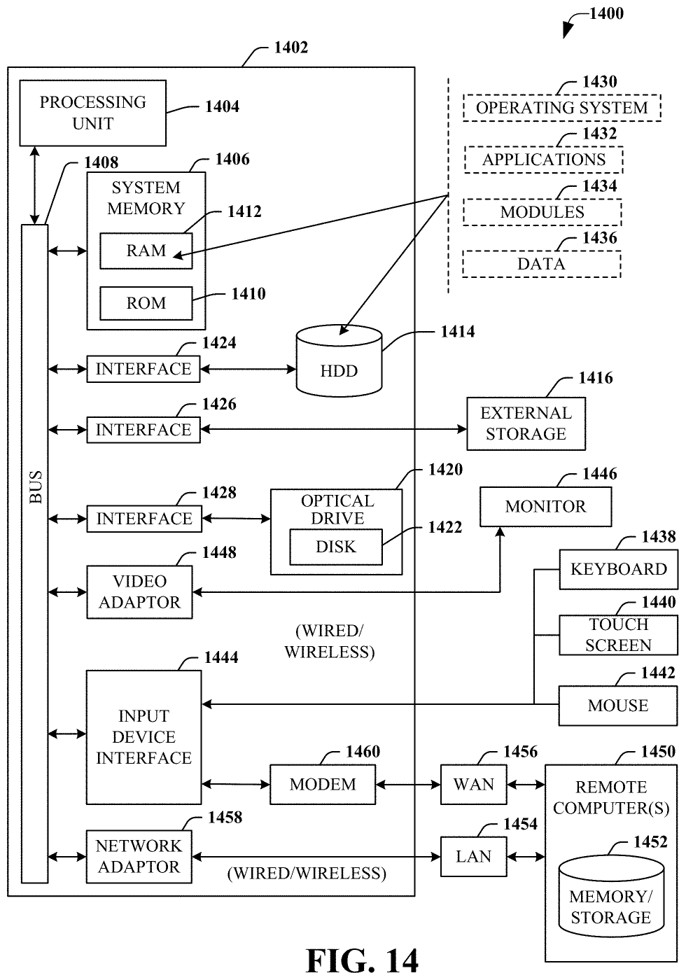

In order to provide additional context for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A Basic Input/Output System (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and a drive 1420, e.g., such as a solid state drive, an optical disk drive, which can read or write from a disk 1422, such as a CD-ROM disc, a DVD, a BD, etc. Alternatively, where a solid state drive is involved, disk 1422 would not be included, unless separate. While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and drive 1420 can be connected to the system bus 1408 by an HDD interface 1424, an external storage interface 1426 and a drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally include emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can include one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enable with a security module, such as a trusted processing module (TPM). For instance with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above, such as but not limited to a network virtual machine providing one or more aspects of storage or processing of information. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

An aspect of 5G, which differentiates from previous 4G systems, is the use of NR. NR architecture can be designed to support multiple deployment cases for independent configuration of resources used for RACH procedures. Since the NR can provide additional services than those provided by LTE, efficiencies can be generated by leveraging the pros and cons of LTE and NR to facilitate the interplay between LTE and NR, as discussed herein.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” and the like are intended to refer to, or can include, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device,” “user equipment” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

The various aspects described herein can relate to New Radio (NR), which can be deployed as a standalone radio access technology or as a non-standalone radio access technology assisted by another radio access technology, such as Long Term Evolution (LTE), for example. It should be noted that although various aspects and embodiments have been described herein in the context of 5G, Universal Mobile Telecommunications System (UMTS), and/or Long Term Evolution (LTE), or other next generation networks, the disclosed aspects are not limited to 5G, 6G, a UMTS implementation, and/or an LTE implementation as the techniques can also be applied in 3G, 4G, or LTE systems. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies.

As used herein, “5G” can also be referred to as NR access. Accordingly, systems, methods, and/or machine-readable storage media for facilitating link adaptation of downlink control channel for 5G systems are desired. As used herein, one or more aspects of a 5G network can include, but is not limited to, data rates of several tens of megabits per second (Mbps) supported for tens of thousands of users; at least one gigabit per second (Gbps) to be offered simultaneously to tens of users (e.g., tens of workers on the same office floor); several hundreds of thousands of simultaneous connections supported for massive sensor deployments; spectral efficiency significantly enhanced compared to 4G; improvement in coverage relative to 4G; signaling efficiency enhanced compared to 4G; and/or latency significantly reduced compared to LTE.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification procedures and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A method, comprising:
determining, by a device comprising a processor, that communication failures have been experienced by a first user equipment and a second user equipment of a group of user equipment, wherein the determining comprises determining that a first endpoint report is associated with the first user equipment and that a second endpoint report is associated with the second user equipment;
facilitating, by the device, recovery of a network infrastructure that comprises network equipment determined to deliver respective services to the first user equipment and the second network equipment, a first path connecting the network equipment with the first user equipment, and a second path connecting the network equipment with the second user equipment, wherein the facilitating comprises reconstructing a first configuration of the first path based on first information comprised in the first endpoint report and a second configuration of the second path based on second information comprised in the second endpoint report;
superimposing, by the device, a first representation of respective locations of the first user equipment and the second user equipment onto a second representation of the network infrastructure;
identifying, by the device, a shared network equipment of the network equipment based on the shared network equipment being included in the first path and the second path; and
facilitating, by the device, implementation of an action at the shared network equipment, wherein the action is responsive to the communication failures.

2. The method of claim 1, wherein the identifying comprises determining the first path and the second path are a same path.

3. The method of claim 1, wherein the identifying comprises determining the first path and the second path are linked at the shared network equipment.

4. The method of claim 1, further comprising:
prior to the superimposing, determining that the network equipment further delivers services to a third user equipment, wherein the superimposing comprises superimposing a third representation of a third location of the third user equipment onto the network infrastructure, and wherein a communication failure is not indicated at the third user equipment.

5. The method of claim 1, wherein facilitating the recovery comprises recreating transient portions of the first path, and wherein the transient portions are associated with a software defined network.

6. The method of claim 1, wherein facilitating the recovery comprises:
facilitating a first recovery of a first group of network equipment, wherein the first group of network equipment is representative of a first group of trees of the network infrastructure, and wherein respective first trees of the first group of trees represent respective first network infrastructure equipment utilized to deliver a first service of the respective services to the first user equipment; and
facilitating a second recovery of a second group of trees of the network infrastructure, wherein respective second trees of the second group of trees represent second network infrastructure equipment utilized to deliver a second service of the respective services to the second user equipment.

7. The method of claim 6, further comprising:
prior to facilitating the first recovery of the first group of trees, determining that a defined threshold value indicative of a minimum number of user equipment permitted to experience communication failures has been satisfied.

8. The method of claim 1, wherein the shared network equipment is a lowest common node within the network infrastructure.

9. The method of claim 1, wherein the identifying comprises:
weighting the network equipment based on respective proximities of the network equipment to the first user equipment and the second user equipment.

10. The method of claim 1, wherein the identifying comprises:
weighting the network equipment based on respective arrival times of indications of the communication failures.

11. A system, comprising:
a processor; and
a memory that stores executable instructions that, when executed by the processor, facilitate performance of operations, the operations comprising:
establishing a restoration of a group of communication paths of a network infrastructure that comprises network nodes between a root network node and a leaf network node, wherein a fault is determined to exist in the group of communication paths between the root network node and the leaf network node, wherein the establishing is based on a report issued responsive to detection of the fault, wherein the report comprises information indicative of a linkage of network nodes between the root network node and the leaf network node, wherein the root network node comprises edge equipment, and wherein the leaf network node comprises endpoint equipment;
determining that a defined network node of the network nodes is a source of the fault based on respective positions of user equipment experiencing the fault relative to the defined network node; and
removing the fault based on controlling a functionality of the defined network node.

12. The system of claim 11, wherein the determining comprises determining that the respective positions of the user equipment are represented along a communication path, and wherein the defined network node is a closest node to the user equipment experiencing the fault.

13. The system of claim 11, wherein other nodes, other than the root network node and the leaf network node and located between the defined network node and the user equipment, are determined not to be common to the user equipment experiencing the fault, and wherein the operations further comprise eliminating the other nodes as being a source of the fault.

14. The system of claim 11, wherein the determining comprises determining that first communication paths and second communication paths of the group of communication paths diverge at the defined network node.

15. The system of claim 11, wherein the operations further comprise:
applying respective weights to the network nodes based on respective proximities of the network nodes to the user equipment and based on respective arrival times of information indicative of the fault.

16. The system of claim 15, wherein the operations further comprise:
identifying the defined network node based on the defined network node being assigned a weight of the respective weights that is more than weights of the respective weights assigned to other network nodes other than the defined network node.

17. The system of claim 11, wherein the establishing comprises restructuring transient portions of the group of communications paths, and wherein the transient portions are associated with a software defined network.

18. A non-transitory machine-readable medium, comprising executable instructions that, when executed by a processor, facilitate performance of operations, the operations comprising:
recovering a network infrastructure based on a determination that a communication fault has occurred within a network, wherein the network infrastructure comprises a group of network equipment determined to provide services to a group of user equipment, a first path connecting the group of network equipment with first user equipment of the group of user equipment, and a second path connecting the group of network equipment with second user equipment of the group of user equipment, wherein the recovering comprises:
determining the first path based on a first trouble report that comprises first information indicative of a first mapping between the group of network equipment and the first user equipment, and
determining the second path based on a second trouble report that comprises second information indicative of a second mapping between the group of network equipment and the second user equipment; and
selecting a network equipment from the group of network equipment based on the network equipment being a closest network equipment to the first user equipment and the second user equipment, and based on the network equipment being utilized to provide services to the first user equipment and the second user equipment, wherein the selecting identifies the network equipment as a source of the communication fault.

19. The non-transitory machine-readable medium of claim 18, wherein the operations further comprise determining the network equipment is the closest network equipment based on the network equipment being a node that routes first data via the first path to the first user equipment and second data via the second path to the second user equipment.

20. The non-transitory machine-readable medium of claim 18, wherein the network equipment is a first network equipment, wherein the operations further comprise determining the first network equipment is the closest network equipment based on detection of the communication fault existing between the first network equipment and a second network equipment, and wherein the second network equipment is in a closer proximity to the first user equipment than the first network equipment.
